(19) United States
(12) Patent Application Publication
(10) Pub. No.: US 2005/0002835 A1
(43) Pub. Date: Jan. 6, 2005

(54) Micro-engineered reactor

(75) Inventors: John E.A. Shaw, West Drayton (GB); Richard E. Shute, Macclesfield (GB)

Correspondence Address: OLIFF & BERRIDGE, PLC, P.O. BOX 19928, ALEXANDRIA, VA, 22320, US

(73) Assignee: AstraZeneca AB, Soderstalje (SE)

(21) Appl. No.: 10/836,250

(22) Filed: May 3, 2004

Related U.S. Application Data
(63) Continuation of application No. PCT/GB02/04953, filed on Nov. 1, 2003.

(30) Foreign Application Priority Data
Nov. 1, 2001 (GB) 0126281.5

(51) Int. Cl. B01J 19/00

(52) U.S. Cl. 422/130

(57) ABSTRACT

A chemical reactor and method of using the same. The reactor comprises first and second micro-engineered discrete flow passages for receiving chemical fluids. The first fluid passage receives a first chemical fluid in which a chemical change or reaction in the fluid can be initiated by subjecting the fluid to a stimulus. A stimulation means is located in, or adjacent to, the first flow passage, and is operable to stimulate a chemical change or reaction in the first fluid. The second micro-engineered discrete flow passage receives a second chemical fluid which will interact with the stimulated first fluid when contacted by the stimulated first fluid. The first and second flow passages converge at a first region to form an outlet passage within which the first and second fluids may contact each other.

The invention relates to devices in which chemical reactions are performed, and in particular to chemical reactors in which a reaction is caused to occur by exposure of at least one reactant to a stimulus that may include a radiated stimulus.

The term “stimulus”, as used herein, includes any stimulus of radiated electromagnetic origin such as light, including such radiation selected from the full frequency ranges from Gamma and X-rays, UV, visible light, IR, heat, microwave and radio waves which can be transmitted to a reagent via a transmissive or conductive medium, wall, or opening. Such “stimulus” described herein may also include particulate radiation such as nuclear particle beams, electron beams, cosmic rays, alpha and beta particles.

There is a need for a chemical reactor in which a first reagent fluid is exposed to a stimulus and subsequently brought into contact with a second reagent fluid, not exposed to that stimulus, to produce a product fluid, without that product fluid being exposed to the same stimulus. The stimulus involves a transfer of energy, or charge, or both, to convert a source material to a primary product that promotes a desired combination, conversion, or reaction with a precursor material to generate a secondary product. Usually the source material is, or is contained in, a first reagent fluid, and the precursor material is, or is contained in, a second reagent fluid.

Electromagnetic fields may also provide the stimulus, or electrical currents applied to a region of the device where the first reagent fluid is temporarily held or through which, the reagent fluid is passed.

Prior known reactions caused to occur by exposure of reactants to a stimulus such as a radiative stimulus are performed on a macro scale such as, for example, by exposing a container of the necessary chemicals to the stimulus. The utility of such basic techniques are limited by extended exposure, mixing and separation times in macro scale systems. These do not readily allow selective stimulus of one reagent to generate a reactive primary product without exposing other reagents and the products to the same stimulus.

Alternative techniques have been used in the past, to try to enhance performance by the use of macro-scale channel, or falling-film, reactors. In macro-scale channels, it is difficult to provide efficient exposure to a stimulus in combination with short transfer time through the stimulus region and to any subsequent mixing and reaction region. Falling film reactors, for exposure to radiation of a reagent such as a liquid film stream, either free of contact with other surface, or as a layer in contact with one or more surfaces, allow fluid to pass as a thin film through an area in which the fluid is exposed to the radiated stimulus (typically light). This reduces transmission distances through the film and allows more even and rapid exposure than exposure of bulk materials, but does not provide a suitable structure or means for rapid mixing and reaction with non-exposed material, or protection of products from exposure.

Such prior known macro scale techniques are adequate for simple reactions, such as the removal of photo-labile protecting groups, (such as sulphonic acid esters and o-nitrobenzyl ethers) to generate products that are relatively stable but available for reaction with suitable reactants. However, such techniques are not satisfactory when the product of the protective group removal, or other initial reaction, is itself unstable, or where reaction of the product with a second photo-labile chemical in a continuous manner is required, or where the generation of a photo-labile product in a continuous manner is required.

For some purposes it is desirable that a chemically active reagent, generated as a primary product by the stimulus from a first chemical, reagent mix, or source material, be rapidly mixed and reacted with a second chemical, reagent mix, or precursor material, so the primary product is not lost by degradation or side reactions, and thereby increases the yield of the desired secondary product. In macro a system, mixing times and times to transfer materials in, and out, of a vessel or environment, can be long. In such systems, it is commonly necessary simultaneously to expose to the stimulus both the first and second chemicals, (or reagent mixes) and the generated primary and secondary products, contained in a single environment. The application of such conventional system is limited if the second chemical or reagent mix, or the products, are labile to the stimulus applied to convert or activate the first chemical or reagent mix. A material labile to a stimulus may be changed or degraded by the stimulus. Action of the stimulus on the second chemical or reagent mix, and/or, on the products, can generate unwanted products or contaminants, and lead to low yield of the desired product. The present invention addresses the need to protect some reagents and products from exposure to the stimulus.

In some cases, it is desirable that a chemical group labile to the stimulus is introduced into the secondary product, possibly via the second chemical or regent mix, so that the secondary product may itself be used in a subsequent reaction promoted by the stimulus. Such stimulus-labile chemical groups may constitute part of a protective group included in a molecule for the purpose of preventing a reaction at a stage before that group is removed with the aid of the stimulus. In such cases, mixing the first and second chemicals, or reagent mixes, followed by exposure to the stimulus, will not yield the desired products due to degradation of the second reactant or products or both.

It is known from U.S. Pat. No. 5,674,742 to replicate a single molecule of DNA by a polymerase chain reaction process (PCR). This well established procedure requires the repetition of heating (denaturing) and cooling (annealing) cycles in the presence of an original DNA target molecule, specific DNA primers, deoxynucleotride triphosphates, and DNA polymerase enzymes and co-factors.

The U.S. patent discloses breaking down the cells throy lysis to extract the DNA molecules prior to the PCR process using a variety of techniques including subjecting the cells to ultrasonic waves. Cell lysis can also be induced electrically or chemically to extract the DNA molecules.

The U.S. patent discloses a micro-engineered apparatus for replicating DNA using the PCR process and uses lambwave transducers to pump and stir the DNA samples and lambwave sensors to monitor viscosity of the amplified DNA as a function of temperature.

The U.S. patent does not disclose the concept of modifying the chemistry of one or more reagents in a reaction process using an external stimulus as is the case of the present invention.

An object of the present invention is to provide a chemical reactor and a method of operating the same, that overcomes at least some of the problems encountered in the past with macro scale apparatus. and exploits the advantages of micro-engineered flow passages.

A further object of the present invention is to provide a micro-engineered reactor device that is suitable for the synthesis of organic compounds in which selected chemical fluids, such as source materials, reagents, precursors, or reaction products, can be exposed to a stimulus, whilst other chemical reagents, precursors or reaction products used in the chemical reactions carried out in the reactor, are shielded from the stimulus.

According to one aspect of the present invention, the reactor as claimed in the attached claims enables a first reagent fluid to be transferred through micro -engineered flow passages and a micro-engineered reaction chamber, such that a first fluid is exposed to the stimulus at controlled dimensions, for a controlled time, allowing efficient exposure of the source material to the stimulus, and the stimulated first fluid is then rapidly transferred from the exposure region to a micro-engineered mixing, or mixing and reaction, region, where the first fluid is brought into contact with the second fluid, that is not exposed to the stimulus.

According to a second aspect of the present invention as claimed in the attached claims, there is provided a method of effecting chemical reactions that enables a first reagent fluid to be transferred through micro-engineered flow passages and a micro-engineered reaction chamber, such that a first fluid is exposed to the stimulus at controlled dimensions, for a controlled time, allowing efficient exposure of the source material to the stimulus, and the stimulated first fluid is then rapidly transferred from the exposure region to a micro-engineered mixing, or mixing and reaction, region where the first fluid is brought into contact with the second fluid, that is not exposed to the stimulus.

Exploiting micro-engineering technology for the manufacture of the reactors of the present invention allows construction of devices with short material and energy transfer distances, thereby reducing transit and mixing times. The micro-engineered reactors according to the present invention allow application of a stimulus selectively to a confined region into which a fluid containing a first chemical or reagent mix, (the source material), is passed for conversion to a primary product, and rapid transfer of fluid containing that primary product to an adjacent region not exposed to the stimulus wherein there is rapid mixing of the primary product fluid with fluid containing a second chemical or reagent mix, the precursor material to generate the secondary product. This allows use of second chemicals or reagent mixes, and formation of products labile to the effects of the stimulus used.

Furthermore, by employing chemical reactors of micro-engineered dimensions, it is possible to achieve short transmissive or absorption pathways for the stimulus, thereby allowing efficient exposure of all material in a fluid layer to that stimulus. The short distance across fluids to surfaces that can be cooled, avoids excessive temperature changes, either from energy absorbed as a result of material interaction with the stimulus, or from subsequent reactions of high-energy products. Flowing reagents through relatively narrow channels, or chambers, allows rapid diffusive transfer of reagents through the fluid layer thickness, so that precursor reagents can be efficiently and rapidly presented to the primary products generated by the radiated stimulus. Generating the active primary product and subsequent products in the device as required, avoids the accumulation of unstable and possibly hazardous compound inventory, and the device provides a level of confinement and avoids dangers inherent in handling of the materials.

Micro-fabrication techniques are known in the semiconductor industry for the manufacture of integrated circuits and for the miniaturisation of electronics. It is also possible to fabricate intricate fluid flow systems with channel sizes as small as a micron (10-6 metre). These devices can be mass-produced inexpensively, and are expected soon to be in widespread use for simple analytical tests. See, e.g., Ramsey, J. M. et al. (1995), “Microfabricated chemical measurement Systems,” Nature Medicine 1:1093-1096; and Harrison, D. J. et al. (1993), “Micro-machining a miniaturised capillary electrophoresis-based chemical analysis system on a chip,” Science 261:895-897. Miniaturisation of laboratory techniques is not a simply a matter of reducing their size. At small scales, different effects become important, rendering some processes inefficient, and others useless. It is difficult to replicate smaller versions of some devices because of material or process limitations. For these reasons it is necessary to develop new methods for performing common laboratory tasks on the micro-scale.

Devices made by micro-machining planar substrates have been made and used for chemical separation, analysis, and sensing. See, e.g., Manz, A. et al. (1994), “Electro-osmotic pumping and electrophoretic separations for miniaturised chemical analysis system,” J. Micromech. Microeng. 4:257-265. In addition devices have been proposed for preparative, to analytical and diagnostic methods which bring two streams of fluid in laminar flow together which allows molecules to diffuse from one stream to the next, examples are proposed in WO9612541, WO9700442 and U.S. Pat. No. 5,716,852.

In this disclosure, the terms “microfabricated” and “micro-engineered” are used synonymously, and includes devices capable of being fabricated on plastic, glass, silicon wafers, or any other material readily available to those practising the art of microfabrication, using such techniques as photolithography, screen printing, wet or dry isotropic and anisotropic etching processes, reactive ion etching (RIE), laser assisted chemical etching (LACE), laser and mechanical cutting of metal, ceramic, and plastic substrates, plastic laminate technology, LIGA, thermoplastic micro-pattern transfer, resin based micro-casting, micromolding in capillaries (MIMIC), and, or other techniques known within the art of microfabrication. As in the case of silicon microfabrication, larger wafers can be used to accommodate a plurality of the devices of this invention in a plurality of configurations. A few standard wafer sizes are 3″(7.5 cm), 4″(10 cm), 6″(15 cm), and 8″(20 cm). Application of the principles presented herein using new and emerging microfabrication methods is within the scope and intent of the present invention. Microfabricated devices may be created through combinations of manufacturing processes such as: (1) photolithography, the optical process of creating microscopic patterns (2) etching, the process that removes substrate material and (3) deposition, the process whereby materials with a specific function can be coated onto surface of the substrate.

Connections with liquid reservoirs external to the device may be made by a variety of means including adhesive bonding to fine tubes and capillaries, anodic or other bonding to manifold structures linked to macroscopic unions, or methods in accordance with Mourlas N. J. et al. Proceedings of the μTAS'98 Workshop, Kluwer Academic Publishers 27−, and references cited therein.

In this disclosure, the term “fluid” means a gas, a super critical gas, or an aqueous or non-aqueous liquid or a solution of one or more chemical compounds in an aqueous or non-aqueous solvent. Preferably the fluid is a liquid or a solution.

By using micro-engineering techniques, the depths of features are generally defined by etching or deposition of material and it is possible to form conduits or flow channels with depth dimensions down to ˜1 μm. In general in the present invention, the term “micro-engineered” refers to channels with depths (d) of 0.1 to 1000 μm. Although channel depths up to 1000 μm allow significantly greater throughputs, and lower flow resistance, the preferred range of sizes are between 1 to 500 μm and especially 30 to 300 μm. Channel widths (w) and lengths (I) are generally defined by lithographic techniques, and may range from a few micrometers to centimetre dimensions (typically 1 μm to 10 μm). By using combinations of such conduits or flow channels, transit and mixing times of the order of seconds down to milliseconds in liquids, and microseconds in gases may be achieved.

Operation of devices according to the present invention involves a number of transport processes that are affected by device construction and dimensions so that the preferred device dimensions are within the range appropriate for micro-engineering techniques. Processes involved, typically include absorption of radiation, migration and diffusion of materials and reagents, mixing of fluid reagent streams, reaction, and heat generation, or consumption and heat transport. As described later, the conditions for efficient exposure of reagents to physical stimuli, rapid migration, and material transfer by diffusion, and heat transfer across fluid layers in a reactor, are improved, and the ratio of reaction flux to reaction zone volume can be enhanced, where cross layer thickness (d) are in the micro-engineering range from 1 μm to 1000 μm, and preferably in the range 30 μm to 300 μm.

A number of chemical reactions can be performed in which a chemical, or reagent mix, or source material, is exposed to a radiated stimulus, whereby the stimulus causes the conversion of the source material to form a primary product. The primary product, which may be an activated complex, may be combined with a second chemical mix or precursor reagent to form a secondary product.

A synthetic chemistry reactor constructed in accordance with the present invention enables a source material as, or in, a fluid to be exposed selectively to a stimulus in a confined region of the device for conversion to a primary product. This allows rapid transfer of fluid containing that primary product to an adjacent region not exposed to the stimulus, wherein there is rapid contact or mixing of the primary product fluid with second fluid consisting of, or containing, a precursor material to generate the secondary product. This allows use of precursor materials or reagent mixes labile to the effects of the stimulus used, and formation of products labile to that stimulus, without degradation or unwanted conversion,

Control of exposure of fluid within regions of the device may be achieved by the use of a passive stimulus, or by use of transmissive, or non-transmissive materials, or structures, or by active structures such as shutters or steerable wave-guides, or by a combination of passive and active materials or structures. Regions of exposure may thereby be controlled spatially or temporarily, or both. The stimulus may be transmitted from a generator to the window region through free space or through a transmissive structure such as, for example, a wave-guide or optical fibre. The termination of such a structure at the reactor device may form or constitute the window.

Due to the short conduit lengths and small dimensions across conduits which can be achieved in microfabricated devices, fluid transfer distances and times, including diffusion distances within the fluid, are dramatically lowered, allowing for rapid combination of fluid streams and diffusive mixing. Reaction rates may be affected by many different factors such as chemical kinetic factors and material transport of fluids, and of dissolved or suspended material by convective, advective, or diffusive processes. Within the microfabricated device, fluid-flow is generally laminar and turbulence suppressed, so that molecular migration processes such as diffusion and electromigration, are the dominant modes of movement of molecules through the liquid. Where diffusive transfer is the limiting factor in transfer of molecules between fluid streams, then the rate of diffusive transfer, is related to the length of the path across streams through which the molecules diffuse, and the geometry of the liquid body. Times to complete diffusive transfer processes will, depending on the boundary conditions, generally be inversely related to the path length, or path length squared.

The device of the present invention involves regions for generation of primary product by application of a stimulus to a source material, and for combination and/or reaction of primary product with precursor reagent to generate secondary product. These regions for stimulation and combination will be different so that precursor and secondary products are not subject to the stimulus. Further regions, and reaction zones for mixing and reaction of products and reagents, may be incorporated into the device. The device may contain regions for controlling the temperature of the primary product generation and reaction zones. Heat may be generated in the region exposed to stimulus and by chemical reactions such as those between primary products and precursor reagents. The source materials and precursor reagents may themselves be produced as products of devices of the present invention, and different stimuli may be used in combination in the same or different regions of a device, or assembly of such devices.

Device construction and dimensions affect transport processes in devices according to the present invention, therefore the preferred device dimensions are within the range appropriate for micro-engineering techniques. In general, as will be shown below, efficiency of exposure to stimuli, rates of material transport and formation, and transfer of heat from, or to, the fluids and reaction sites, is improved by fabricating devices where distances across structures and fluid flows are small, and fall within the range applicable to micro-engineering techniques.

Typically, the generation of primary products involves exposure of a fluid consisting of, or containing, a source material to a stimulus, such as a radiative stimulus e.g. light, at a region within the device that is provided with a window that is transmissive or conductive to the stimulus. The primary product generated transfers into a fluid-flow to a separate combination or/and reaction site within the device not exposed to that stimulus. The reaction site may be exposed to other selected stimuli. Heat may be generated, or absorbed, as a result of the exposure to the stimulus and subsequent reactions. Maintenance of a desired temperature regime will be aided by minimising thermal transport distances across fluids and walls to heat exchangers, heat sinks, or heat sources.

Precursor reagents and primary product are brought together by fluid flow at a separate reaction site. Combination or mixing of precursor and primary product will typically involve diffusive transfer across the fluid streams. Rates of reaction between primary product and precursor can be transport limited, and such transport limitations on rates will be reduced by minimising material transport distances across fluid layers.

Some generation or absorption of heat will generally be associated with reaction of primary product and precursor material to produce a secondary reaction product. Where the primary. product is a reactive material the reaction will generally be exothermic. Whether heat is evolved or absorbed, maintenance of stable temperature regimes is improved by short thermal transport distances from the reaction site to heat exchangers, sinks, or sources across intervening fluid layers and wall materials.

Reaction of secondary reaction product carried by flow to a further reaction site will similarly involve mixing, heat generation or absorption and heat transfer and enhancement of rates of diffusive transport and thermal conduction will be achieved by minimising the relevant transport distances.

The device geometry and dimensions affect the speed and efficiency of each of the processes described and reactors of the present invention are employed to enable rapid and efficient mass and heat transport.

Material transfer across and between flow streams may occur by migration, or diffusion. Regions for reaction or mixing may be considered as a channels or chambers of depth d, width (w), and length 1, where t is the transit time for fluid flowing along the length of a channel. Temperature changes can be related to the residence time t over which the processes causing heat generation or consumption occur, to the heat generation or consumption rates, to the thermal capacity of fluids and other materials in the device, and to the thermal time constant for heat transfer processes which will be a function of thermal diffusivity, and dimensions such as distance across fluid and other layers to conductive heat sink structures. In order that close control be exercised over the temperatures within the material transport and reaction regions, it is should be ensured that thermal time constants associated with a region are low.

If any of the materials, such as the source materials, solvents, reagents, or products are thermally labile then temperature rises should be limited. In any case, the yields or rates of processes generating first and second products are likely to be temperature dependent and so control of temperature in the device is desirable. In general, temperature control is improved by maintaining short thermal transfer distances and is therefore, readily improved in micro-engineered devices. The performance of the heat transfer process may generally be related to a dimensionless parameter of the form μt/d² where μ is thermal diffusivity, t is time allowed for heat transfer, and d is distance to a conductive heat sink surface. Where μt/d²>˜1 then thermal equilibrium has been largely achieved. Taking t in μt/d²=1 as a thermal time constant and rearranging gives t=(d²/μ) and clearly this is decreased for small values of d. Some example values relating thermal diffusivities, conduction lengths and time constants are tabulated below:

| | Material | Water | CCl₄ | Toluene | Air |
|---|---|---|---|---|---|
| Thermal | 10⁻⁷ m²/K | 1.45 | 0.76 | 0.91 | 817 |
| Diffusivity μ | | | | | |
| Thickness | | time | time | time | time |
| μm | | seconds | seconds | seconds | seconds |
| 10 | | 6.9E−04 | 1.3E−03 | 1.1E−03 | 5.3E−06 |
| 30 | | 6.2E−03 | 1.2E−02 | 9.9E−03 | 4.8E−05 |
| 100 | | 6.9E−02 | 1.3E−01 | 1.1E−01 | 5.3E−04 |
| 300 | | 6.2E−01 | 1.2E+00 | 9.9E−01 | 4.8E−03 |
| 1000 | | 6.9E+00 | 1.3E+01 | 1.1E+01 | 5.3E−02 |
| 3000 | | 6.2E+01 | 1.2E+02 | 9.9E+01 | 4.8E−01 |

These value suggest that for liquids, thermal considerations indicate for required transit times of ˜1 sec, liquid thickness (d) should be 100 μm or less.

These value indicate that for short thermal response times of less than one second, liquid layer thickness (d) should be 300 μm or less. For cases with very short lived species, and requires residence times of milliseconds, then liquid thickness (d) should be ˜<10 μm For dilute solution non absorbing solvents, or where there is little heat dissipation on photolysis or where rates of energy generation or consumption are low these constraints may not apply. In practice where a structure and its contents form a composite layer with different values of μ and d, the evaluation of the heat transfer characteristics is inevitably more complex but is commonly adequate to identify the most thermally resistant layer and base design calculations on that. Where layers of reagent fluids and solvent are involved, it will usually be adequate to ensure that those are sufficiently thin to avoid maintaining excessive temperature differences, and to contain them by more conductive structures, such as thin metal, glass, or ceramic constructions, linked to heat sinks or sources such as heat exchangers, heat pipes, Peltier coolers, or resistive heaters.

The preferred dimensions for a portion of conduit exposed to a photolytic stimulus so that efficient conversion of source material to reactive primary product is achieved will depend on the transit times allowed by photolysis kinetics and product lifetimes. Generally photolytic processes are very fast and the allowed residence time will depend on the product stability, including kinetics of unwanted side reactions (e.g. dimerisation and polymerisation of reactive species including free radicals, consumption by reaction with carrier solvent, product photolysis, deposition of photolysis products on surfaces including windows). These factors put an upper limit on the time available and desirable for the photolysis process. In principle, providing there is sufficient pressure and a wide enough flow path, it should be possible to achieve arbitrary short residence times. However, penetration of light into the fluid, and dissipation of heat, will limit, in particular, the depth of the illuminated layer. It is difficult to generalise about required dimensions on the basis of photolysis and optical absorption effects, as reagent extinction coefficients, and relative efficiencies of post absorption processes, (quantum yields) will vary greatly between one chemical system and another.

To some extent it should be possible to make any short allowed residence times in the stimulus region adequate by employing sufficiently high illumination fluxes. This has consequences on the cooling needed to remove heat generated by both desired and unwanted absorption processes. Excessive temperature rises may cause unwanted thermolytic process and accelerate unwanted reaction or decomposition of the desired products.

Generally, it will be desirable that the light penetrates right through the fluid layer to ensure that complete conversion is possible. For simplicity, in estimating required fluxes, bleaching/source material consumption, may be neglected. Although this must introduce some errors, removal of absorbing material by photolysis may be expected to increase transmission, so that assumption that the Beer Lambert Law applies should not tend to underestimate required fluxes. From the Beer Lambert Law we have:
I_{λ} I_{λ}°. 10^{εcd} I_{λ} is transmitted radiation wavelength λ
F=I_{λ}/I_{λ}° I_{λ}° is incident radiation
ε is extinction coefficient (cm-1)
c is concentration (fraction)
   d=log₁₀F/−ε.c d is layer thickness (cm)

To avoid unexposed precursor passing through the cell, intensity should be high and thickness (y), corresponding to values of F, not too close to 0. A maximum suitable value for d might correspond to F=0.1. Similarly it would be wasteful for F to be too high. A minimum value for (d) might correspond to F=0.9. A preferred value may be for F=0.5.
dₘₐₓ=1/ε.c, dₘᵢₙ=0.05/ ε.c, d_{pref}=0.3/ε.c

Based on the above, it may be desirable to select concentrations, if possible, such that d_{pref} is within bounds indicated by thermal transport requirements. For d_{pref} to be 100 μm (0.01 cm), the value ε.c˜<3

If the illuminated cell is provided with suitably reflective surfaces it will be possible arrange that unabsorbed light is reflected to pass again through the fluid, achieving optical path lengths greater than the fluid layer thickness.

By operating within micro-engineered reactors, the quantities of liquid used are reduced and diffusion distances within the liquid are dramatically lowered allowing for rapid diffusion. The diffusion rate may be affected by many different factors, such as, chemical kinetic factors and transport of dissolved material in the solvent by convective, advective, or diffusive processes. Within the microfabricated devices, the cross channel dimensions generally ensure that low Reynolds laminar flow conditions apply. Mixing and reaction of species from adjacent flow streams or for species to contact and react with deposits on walls or electrodes it is necessary for those species to cross the flow streams. Turbulent fluid transport is generally absent in devices of micro-engineered dimensions so that movement of species across flow streams proceeds my molecular migration mechanisms such as diffusion or electro-migration. Where diffusive transfer is the limiting factor then the rate of diffusion is related to the length of the path through which the molecule diffuses and the geometry of the liquid body. Diffusive transfer rates will generally be inversely related to the path length (d), or square of the path length, depending on whether the conditions for steady state or transient diffusion apply.

The source material as, or in, a fluid will usually be brought by fluid flow to the region for exposure to the stimulus, but if the source material is electrically charged it may be convenient to transport it through the fluid and conduits by electrophoretic means. Similarly, precursor reagent and primary and secondary products will normally be transported through the device by fluid flow, but if electrically charged they may be transported by electrophoretic means. Transfer across the direction of flow will generally involve diffusive transfer. The length of time required for combination of primary product and precursor materials by transport-limited processes can be estimated on the basis of diffusion processes, where the distance across a flow in the mixing conduit or chamber carrying such materials is taken as the characteristic distance for diffusion calculations. Although a full analysis of the diffusion process can be complex, it is generally adequate to consider the diffusive process will be close to complete when the dimensionless parameter Dt/d²˜>1. This corresponds to near equilibrium, or completion of the diffusive process. (D is diffusion coefficient, t is time allowed for mass transfer, and d is the distance across fluid to the surface (electrode) at which conversion takes place.). Values for residence time based on diffusion provide minimum guide values as longer times may be required if reaction kinetics are not sufficiently fast, and if other transfer process introduce delays e.g. dissolution of solid reactive products.

Acceptable values for the device dimensions and residence times within the stimulus region and the mixing and reaction region will depend on the stability of the reactive product to be formed, and desired throughput.

Typically diffusion coefficients (D) in non-viscous fluids for low to moderate molecular weight species of the size range of interest (Molecular weights of a few hundred of chemicals) will be in the range 10⁻⁵ to 10⁻⁷ cm²s⁻¹. Taking a value for D of 5×10⁻⁶cm²s⁻1, the approximate time (t) for diffusive transfer times across a path length (d) may be derived from expressions of the type Dt/d²=0.01 to 1, where Dt/d²=0.01 approximates to a diffusion front reaching a distance d from source plane, and Dt/d²=1.0 corresponds to near completion of the diffusive process (concentration gradient across d being nearly eliminated). Approximate times (t) for reaching diffusive equilibration (Dt/d²=1.0) at different path lengths (d), in which the dissolved material must travel, based on D=5 ×10⁻⁶ or 5×10⁻⁷ cm²s⁻¹ are tabulated below in the table diffusive mixing times:

| d | D 10⁻⁶ | t seconds for | D 10⁻⁶ | t seconds for |
|---|---|---|---|---|
| micrometers | cm²s−1 | Dt/d² = 1.0 | cm²s−1 | Dt/d² = 1.0 |
| 1 | 5 | 0.002 | 0.5 | 0.02 |
| 3 | 5 | 0.018 | 0.5 | 0.18 |
| 10 | 5 | 0.2 | 0.5 | 2.0 |
| 30 | 5 | 1.8 | 0.5 | 18.0 |
| 60 | 5 | 7.2 | 0.5 | 72.0 |
| 100 | 5 | 20.0 | 0.5 | 200.0 |
| 300 | 5 | 180.0 | 0.5 | 1800.0 |
| 1000 | 5 | 2000.0 | 0.5 | 20000.0 |

About 50% the diffusive transfer will occur in about a tenth of the above times (corresponding to Dt/d²˜0.1). On the basis of the above table relatively rapid equilibration by diffusion alone will occur within 100 seconds where the required transport distance (d) is of the order of, or less than, 100 μm. The relevant distance (d) for the mixing of two fluid streams will be that from the furthest edge of the channel where the two fluids meet. For transfer of material to or from a surface, such as to a primary product deposit on an electrode, (d) is the distance across the fluid stream or layer to that surface. In micro-engineered devices where distance (d) is made small the diffusion controlled transport, mixing, and reaction times are decreased and controlled by the distance (d). Channels with width (w) or height (h) dimensions of the order of 100 μm or less are readily achieved using micro-fabrication techniques allowing structure providing rapid diffusive mixing to be produced.

For processes operating under transport control, reactant consumption and product flow from the reaction zone of a reactor depends on the transit time for fluid flow through the reaction zone and on the time for completion of cross flow diffusive processes in that zone. Selecting flow rates so that reaction zone fluid flow transit times and cross flow diffusion completion times are similar, will result in reaction flux per unit volume of the reaction chamber improving as distance (d) is decreased. This may result in greater heat fluxes from absorption of stimuli or reaction, but as thermal time constants similarly decrease with (d), the temperatures within the device do not rise excessively. Values of dimension (d) from 50 to 1000 μm correspond to an acceptable range for diffusion-limited reaction fluxes in micro-engineered devices. For devices with larger value for (d) the reaction flux rates will be tend to be lower due to diffusion limitation and so production rates per unit device volume will be lower. It is an advantage therefore, that the distance across channels or chambers for mixing or transfer of reagent to reactive deposits be low and this dimension in devices according to the present invention should be 10 to 3000 μm, and preferably in the range 30 to 300 μm.

Where mixing processes other than diffusive mixing are ineffective, the preferred approximate maximal distance across a channel or chamber in the direction which material is required to diffuse is 300 μm. Thus, where two fluids meet in laminar flow, rapid diffusive mixing (˜<100 seconds) requires that the approximate maximal distance across the conduit measured in a plane perpendicular to the interface plane between the two fluid streams (usually the smallest dimension or height in a conduit of rectangular cross section), is 300 μm. Required residence time within a channel or chamber sufficient to allow diffusive mixing will depend on the value of that dimension. This dimension, along with channel width, determines the cross sectional area of the channel, and fluid throughput will depend on the cross sectional area, length of a channel, or chamber, and the fluid flow speed. Although, channel lengths may be quite extended, especially if folded geometries or drawn tubular structures are used in the construction. However, where the channels or chambers are required to incorporate micro-engineered structures such as window, electrodes, and vias, and especially if they are to be rendered by conventional micro-engineering techniques on substantially planar substrates, it is desirable that overall lengths and widths be limited. Typically flow speeds readily achievable for liquids in micro-fluidic systems without excessive pressure, drives the range up to 10 cm/s, and are preferably in the range 0.01 to 1.0 cm/s. Appropriate lengths for conduits employed as a mixing chambers in which diffusive processes are allowed to proceed to completion will range up to 10 cm, and preferably lie in the range 0.1 to 3 cm.

It is not necessary for the purposes of the present invention that laminar flow conditions are maintained for fluid flows within the reactor. Channels and chambers may be made large enough to support turbulent mixing with distances across channels of greater than 0.1 cm, and more conventionally of 1 cm or greater generally being required. Extension of the present invention to larger channels is undesirable due to increases in mixing times, reduction in exposure to stimuli for thicker fluid layers and dispersion within channels, leading to poorer control over residence times Where mixing is to be induced by simple laminar flow of fluids through channels and chambers, the mixing and mass transfer across flow will not be efficient at these dimensions. However efficient mixing may be induced by employing pulsed or reciprocating flows or by employing mechanical agitation of fluid by structures such as stirring paddles or magnetic stirring bars. Additional mixing elements may be added to the reactor device if needed, such as, for example small vanes or deflectors that are shaped and positioned in the chamber and/or the inlet to, or outlet from, the chamber to cause the fluid to swirl or mix

Where two laminar streams run together, the diffusion distance (d) controlling the mixing time will be the channel depth. Where reaction is very fast, and a first stream has an excess of reagent, then the rate-limiting diffusion distance will tend to reduce to that fraction of the channel width corresponding to fluid from the second stream. This will be the case for single and multiphase flows. For multiphase processes the limiting mass transfer distances and times may be altered somewhat, but if the phases are immiscible liquid it is likely that the total result will not change substantially, except as indicated above or if inter-phase transfer is kinetically hindered. If one phase is gaseous, then mass transfer limitations are likely to reside entirely in the liquid phase, and be set by the distances across that liquid phase. Reactions may of course not be mass transport limited. Where kinetic limitations apply for single-phase reactions, it may be adequate to carry out partial or complete mixing in micro-engineered structures, and then transfer the product to a holding container for process completion. For multiphase processes, the degree of subdivision of the phases and the interface geometry will depend critically on how the fluids are contained and moved.

The above indicates that for reaction times in the 0.1-10.0 second range, channel depths (d) of ˜10 to 1000 μm are indicated, and that preferably channel depth will be in the range 30 to 300 μm. The earlier table on diffusive mixing times indicated that if mixing and reaction in millisecond time scales are required for liquid reagents, then the channel depth would have to be ˜1 μm. Total flow rates achievable under those conditions would be quite low (˜1 cc/h or less for 1 cm wide channels). The table below shows values for fluid throughput and transit times for channels with some example dimensions. The combinations of transit times and diffusion distances correspond to significant to full diffusive mixing for species of moderate molecular weights. Limitations to channel length and therefore available transit times at any given flow rate will depend on the size of the structure that can conveniently be fabricated. Values for the required drive pressure for laminar flows in these channels are indicated in the table below.

| Flow rate | Mean | Channel height | | Pressure drop |
|---|---|---|---|---|
| cc/hour | transit | and Diffusion | Channel | bar |
| (for 1 cm | Time | distance | transit length L | (for viscosity 1 |
| width) | t sec | d micrometres | cm | 1 cPoise) |
| 1 | 0.1 | 7 | 0.04 | 3.7E−03 |
| 10 | 0.1 | 7 | 0.39 | 3.7E−01 |
| 100 | 0.1 | 7 | 3.93 | 3.7E+01 |
| 1000 | 0.1 | 7 | 39.28 | 3.7E+03 |
| 1 | 1 | 22 | 0.12 | 3.7E−04 |
| 10 | 1 | 22 | 1.24 | 3.7E−02 |
| 100 | 1 | 22 | 12.42 | 3.7E+00 |
| 1000 | 1 | 22 | 124.22 | 3.7E+02 |
| 1 | 10 | 71 | 0.39 | 3.7E−05 |
| 10 | 10 | 71 | 3.92 | 3.7E−03 |
| 100 | 10 | 71 | 39.28 | 3.7E−01 |
| 1000 | 10 | 71 | 392.83 | 3.7E+01 |

It is clear these short to moderate transit times, that flow rates will generally need to be restricted to less than 100 cc/ hour if channel lengths L or pressure drops are not to be excessive. These flow rates are for 1cm width channels, and relate linearly to channel width. Multiphase reaction depends on being able to maintain a useful inter-phase contact area. This becomes more difficult as dimensions are reduced. While micro-contactors and mesh structures of the type described previously (see International Patent Publication No WO 97/39814.) may be applied where channel depths are 20 μm or greater, the balance between pressures required to drive flow and surface tension forces below for 20 μm depths would tend to produce slugging flow in the phases. Reaction may be maintained in slugging flow but slug dimensions will control diffusion rates, flow rates, and recirculation induced within the slugs, but the diffusion characteristics will not be in accordance with the diffusion model appropriate to simple laminar flows.

The present invention will now be described by way of examples, with reference to the accompanying drawings, in which:

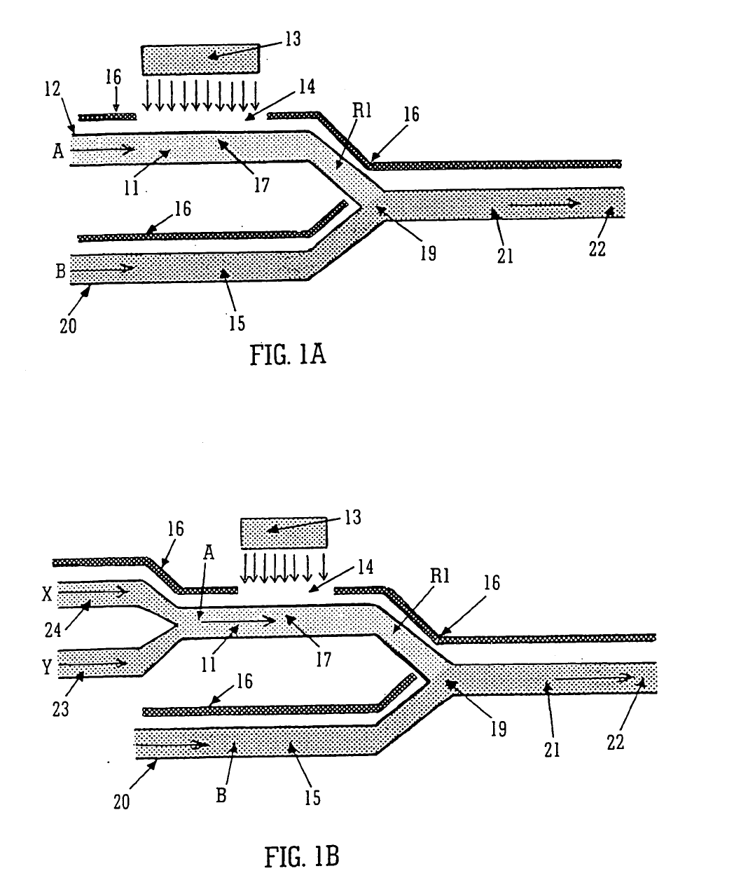

FIGS. 1A and 1B show schematically two arrangements of micro-engineered reactor devices incorporating the present invention.

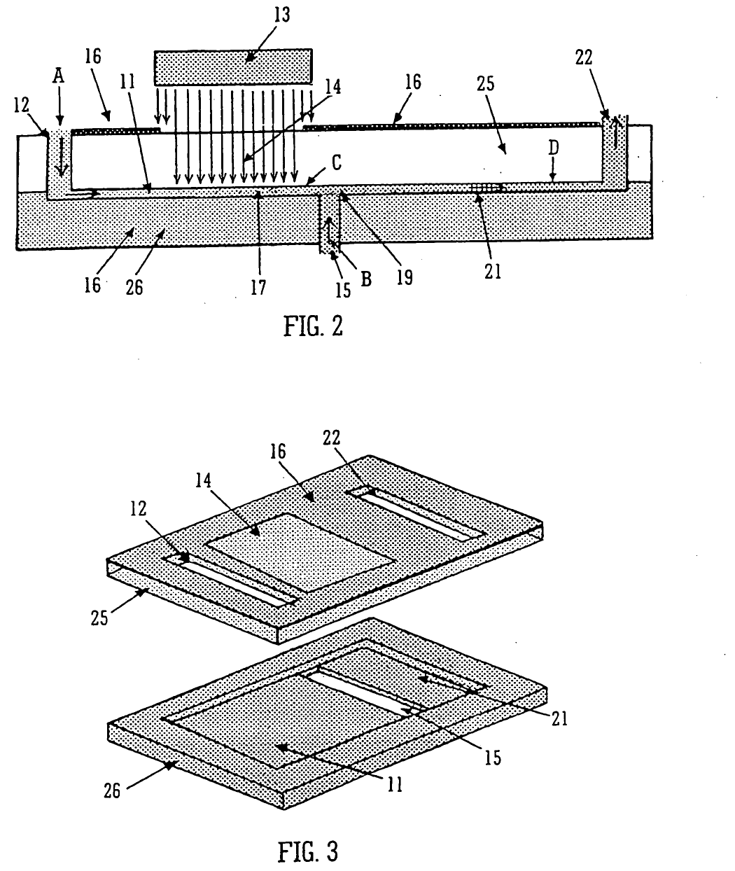

FIGS. 2 to 11 show schematically micro-engineered reactor devices incorporating embodiments of the present invention.

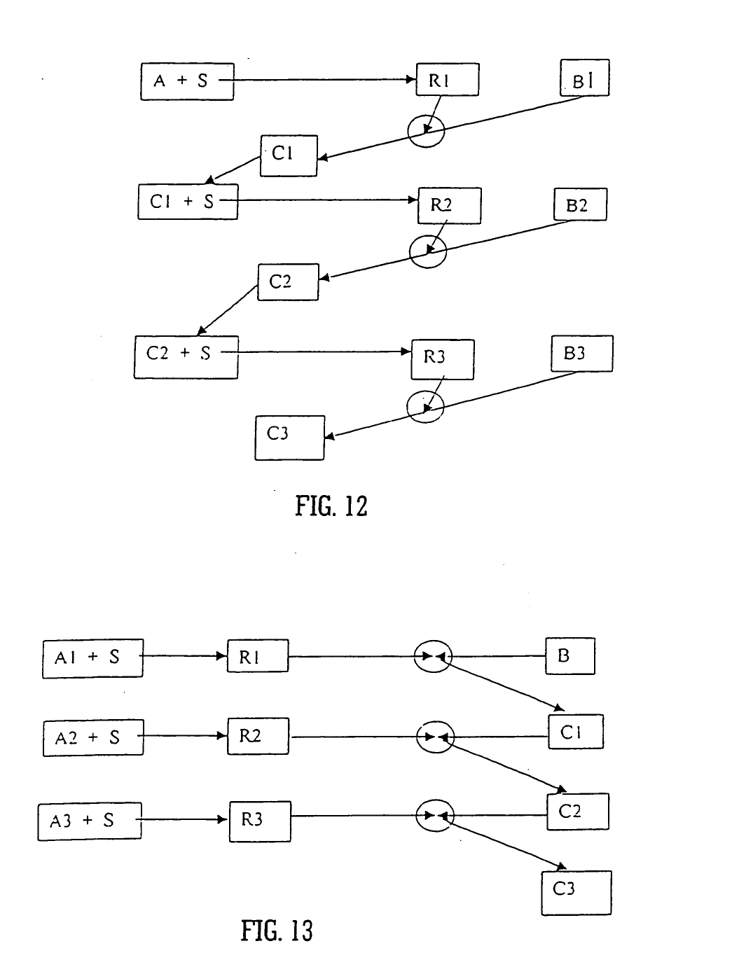

FIGS. 12 to 15 show reaction schemes and sequences facilitated by use of micro-engineered reactor devices incorporating the present invention.

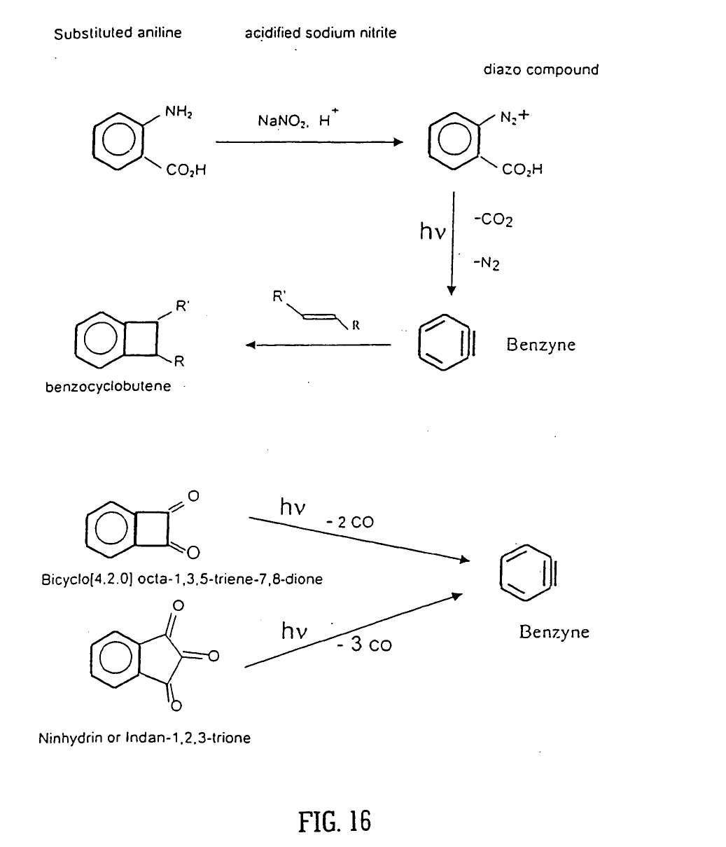

FIGS. 16 to 20 show some example chemical processes that may be employed in reaction schemes and sequences facilitated by use of micro-engineered reactor devices incorporating the present invention.

In the FIGS. 2 and 4 to 11 the reactor devices are shown in cross section such that channel heights and lengths are represented schematically. Channel widths are not indicated but may be similar to the heights of the reactor, or greater, up to the limits imposed by widths of materials or substrates used to fabricate reactor devices.

In general terms, the present invention has a wide application to the synthesis of organic compounds by reaction with a reactive primary product generated by a transmitted energetic stimulus applied to a source material, and especially to reaction with a reactive primary product generated by photochemical conversion of a source material. In general terms a source material is converted by a energetic stimulus to a reactive primary product which is conveyed by flow to a reaction region within a channel, or chamber not exposed to the stimulus and there reacted with a precursor material, so that the primary product and precursor material react to generate a secondary product.

The basic concept of the invention may be represented diagrammatically as in FIG. 1A where the stimulus may be a radiated stimulus such as visible light passing though a section of transparent conduit wall. Other stimuli such as electrical or thermal stimuli may be passed through electrically or thermal conductive materials. Shields 16 are provided to block the passage of the stimulus through the conduits. Reagent A flows through a conduit, where it is subjected to a stimulus which passes through a window in the conduit or a gap in the shield and generates a reagent R1 which is rapidly mixed with a flow of reagent B from a second conduit to form product C. The overall process is thus as represented below:
A+stimulus→R1// R1+B→C

FIG. 1A shows schematically the operation of a process in a reactor according to the present invention. A fluid reagent mix containing source material (A) passes though an entrance 12 and flows through the conduit 11. A stimulus source 13 is provided such that the stimulus enters conduit 11 through a transmissive region or window 14 such that the stimulus acts on the source material in the exposed region 17 to generate a primary stimulation product (R1). Non stimulus, transmissive structures or materials (shields) 16 are provided to prevent the stimulus acting on fluids in other parts of the reactor. A fluid reagent mix containing precursor material (B) passes through an entrance 20 to a conduit 15 not exposed to the stimulus and fluids from conduits 11 and 15 pass to a junction 19 leading to a conduit 21, also not exposed to the stimulus. The Junction 19 forms a reaction region within which the fluid streams Band R1 contact and react to produce a fluid flow 22 containing a secondary product (C). Precursor reagent (B) and secondary product (C) may be, or include, compounds which would be subject to alteration if they passed through the region 17 exposed to the stimulus.

The precursor (A) producing active reagent (R1) may itself be produced within the system from reagents (X,Y) which themselves may be labile to the stimulus, as indicated in FIG. 1B. The overall process there represented is:
X+Y→A // A+stimulus→R1 // R1+B→C

FIG. 1B shows schematically the operation of a process in a reactor according to the present invention where the fluid reagent mix containing source material (A) is generated by combining reagents supplied through conduits 23 and 24 which issue into the conduit 11. One or more of the reagents used to generate the source material may be sensitive to the stimulus applied in region 17 of conduit 11. The contents of supply conduits 23 and 24 may be shielded from the stimulus by non-stimulus transmissive structures or materials 16.

It is to be understood that two or more reactors of the type shown in FIGS. 1A or 1B may be connected in series with the outlet conduit 21 of one of more of the reactors connected to one or more of the conduits 11, 20, 23, 24 of succeeding reactors. In this way different reagents may be used to generate different fluids which when stimulated supply the stimulation products to the conduits 11, 15, 20, 23 or 24 of different reactors.

In FIG. 1B the two converging conduits 23, 24 are shown connected to the first flow passage 11 so that the reagents X and Y react to form the fluid (A). It is to be understood that additionally, or alternatively, the conduits 23, 24 may be connected to the second flow passage 15. In this case reactants X and Y (which may or may not be the same as used to produce fluid (A)) are reacted and discharged into passage 15 to produce the second fluid B for subsequent reaction with product R1.

FIG. 2 represents a chemical reactor system of the type shown in FIG. 1A showing diagrammatically, in cross section, an example construction. The reactor is formed by bonding together of planar substrates 25 and 26 which have etched or milled relief and vias to form the conduits 11, 15, 21, and the reaction region 19. Substrate 25 is transparent to the stimulus except where opaque materials 16, such as deposited and patterned metal films, are positioned to define a window 14. Substrate 26 is an opaque material. Where the stimulus is visible light, the substrate 25 may be glass and substrate 26 may be silicon that can be joined by anodic bonding. In FIG. 2 a fluid reagent mix containing source material (A) passes though an entrance 12 and flows through the conduit 11. A stimulus source 13 such as a lamp is provided such that the stimulus enters conduit 11 through a transmissive region or window 14 so that the stimulus acts on the source material in the exposed region 17 to generate a primary product (R1). A fluid reagent mix containing precursor material (B) passes through conduit 15 not exposed to the stimulus and fluids from conduits 11 and 15 pass to a junction 19 leading to a conduit 21, also not exposed to the stimulus within which the fluid streams contact and react to produce a fluid flow 22 containing a secondary product (C).

The precursor and the reagent generated from it (A and R1), may form or be in phases miscible or immiscible with the material (B) with which they are to be mixed and reacted. Where the fluids are immiscible and they may contact in the mixing/reaction region as parallel streams or as slugs or as bubbles of one phase in the other depending on the flow rates and structure of the mixing region channel.

FIG. 3 represents planar substrates 25, 26 that bonded together form a reactor as represented in cross section in FIG. 2. In FIG. 3 a planar substrate 25 is formed of a transmissive material, for example glass where the stimulus to be employed is visible light. A window 14 for the transmission of the stimulus is provided by an opening through a layer of non transmissive material 16, which for example is where the stimulus to be employed is visible light, an opaque metal film. Vias through substrates 25 and 26 provide for fluid entrance and exit ports 12, 15, and 22 for respectively introduction of source material, introduction of precursor material, and removal of secondary product C. Conduits 11 and 21 linking the vias though the device are formed by combination of relief defined in one or more of substrates 25 and 26 and the process of joining substrates 25 and 26.

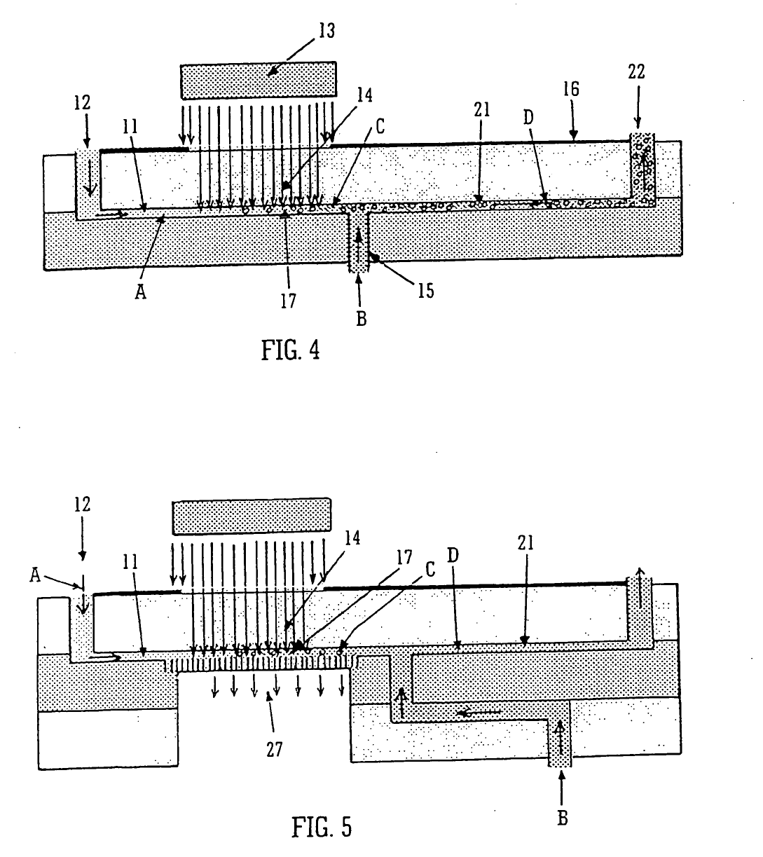

A number of photochemical reactions of use synthetically involve generation of gas. This can lead to large changes in volume (gas generated may be ˜1000 times the volume of reagent). As long as the reagent (A) to be subjected to photolysis is held in sufficiently dilute solution, the gas production may not make any very material difference to operation of the reactor. Gas can be carried through the structure as a dissolved gas or as small bubbles, as shown in FIG. 4. FIG. 4 represents a cross section of planar cell for photochemical processing with gas evolved due to a photolysis reaction in region 17 passing to subsequent reaction stage 21 and leaving with the secondary product at outlet 22. The component parts of the reactor of FIG. 4 that are the same as that of the reactor of FIG. 1A are given the same reference numerals.

Alternatively, a means may be provided for gas release through a membrane that is porous to gas but relatively impervious to the liquid phase. Such an arrangement is represented in FIG. 5. The component parts of the reactor of FIG. 4 that are the same as that of the reactor of Figure la are given the same reference numerals. Gas produced in stimulus region 17 may pass through a microporous sheet material 27. Microporous PTFE is a suitable material for the sheet 27 for the gas separation process from aqueous solutions in particular. Stimulus and gas removal may be spatially separated, with gas removal membranes alternatively, or additionally, positioned to contact the reaction conduit 21.

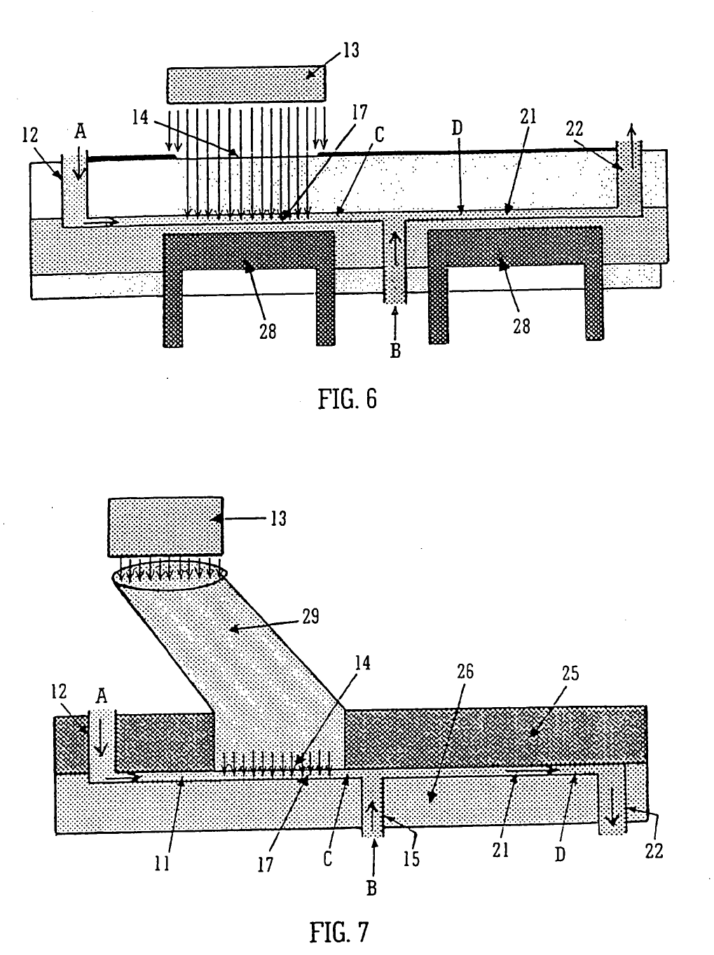

Reaction promoted by a stimulus such as photochemical reactions can be accompanied by significant thermal output. In addition to heat of reaction the process stimulating a precursor to generate an active reagent may be relatively inefficient so that an excess stimulating flux is required. This may result in unwanted heat generation. Where the stimulated process such as photochemical activation is carried out in a relatively thin channel, this excess heat may be removed by means of heat sinks, heat pipes and active cooling means such as flowing coolant adjacent to the stimulus region 17 or positioning a Peltier cooler stage adjacent to the activation area. Such structures can also be used for heating as well as cooling. The reaction of the primary product and precursor may also involve significant thermal output, and reaction caused in both production and consumption of the reactive primary product. It may be important to control the temperature at which the reaction occurs in order to maintain good yields and selectivity. A structure with use of coolant channels 28 adjacent to the sites for stimulated reaction 17 and region 19 where reaction of primary product and precursor 21 occurs is illustrated in FIG. 6. The same reference numbers for those parts of the reactor shown in FIGS. 3 to 5 are used in FIG. 6.

In addition to transmission of the stimulus to a reactor device window 14 through free space as represented in FIGS. 1, 2 and 4 to 6, the reactor may be connected to, or incorporate, a transmissive structure such as, for example, a wave guide or optical fibre. The termination of such a transmissive structure at the reactor device may form or constitute the window 14. This is illustrated diagrammatically in FIG. 7. Stimulus from a generator 13, such as a lamp or laser diode, is transferred to the device via a transmissive link 29, such as an optical fibre or a waveguide, to the stimulus region 17 of the conduit 11 carrying the fluid containing source material. The termination of the transmissive link may form the window 14 or interface with a window structure. The device as represented in FIG. 7 is formed from opaque substrates 25 and 26 having vias and relief formed to provide inlets 12, 15, outlets 22, and internal conduits 11, 15, 21.

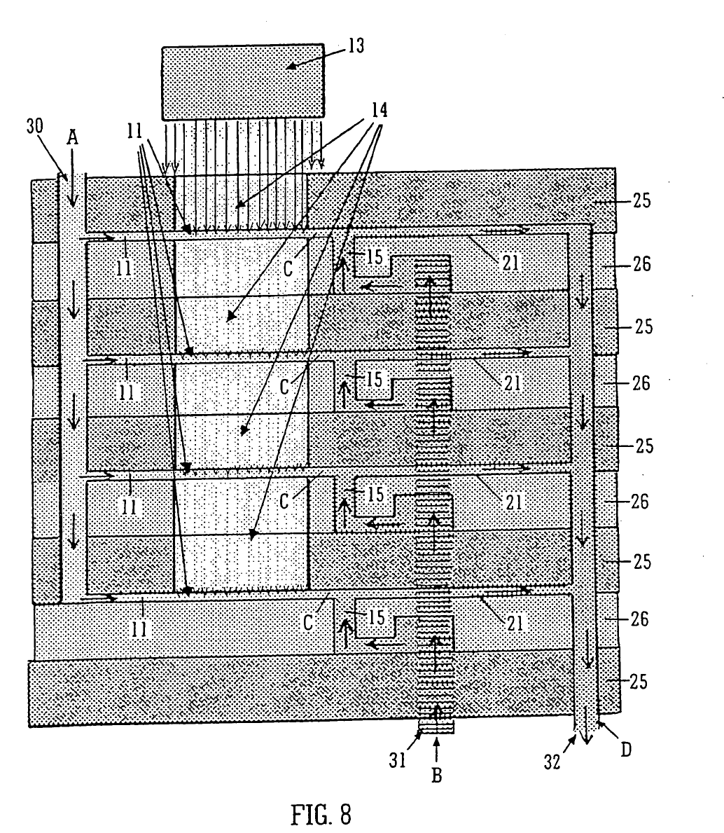

In order to increase throughput or provide for combination of multiple processes of the type facilitated by reactors and processes according to the present invention, it may be convenient to link together a number of reactors. Compact structures incorporating micro-engineered reactors of this type may be provided by stacking and bonding formed substrates 25, 26 where micro-engineering processes such as etching, milling, or patterned depositions provide relief or vias on the substrates which when joined form conduits and manifolds. FIG. 8 represents, in cross section, a stacked structure for increased throughput where the optically transmissive window regions 14 are aligned so that multiple conduits 11 can be exposed to stimulus from a single generator 13. The structure is provided with manifold vias 30, 31, and 32 connecting to the multiple conduits (11, 15, 21) respectively.

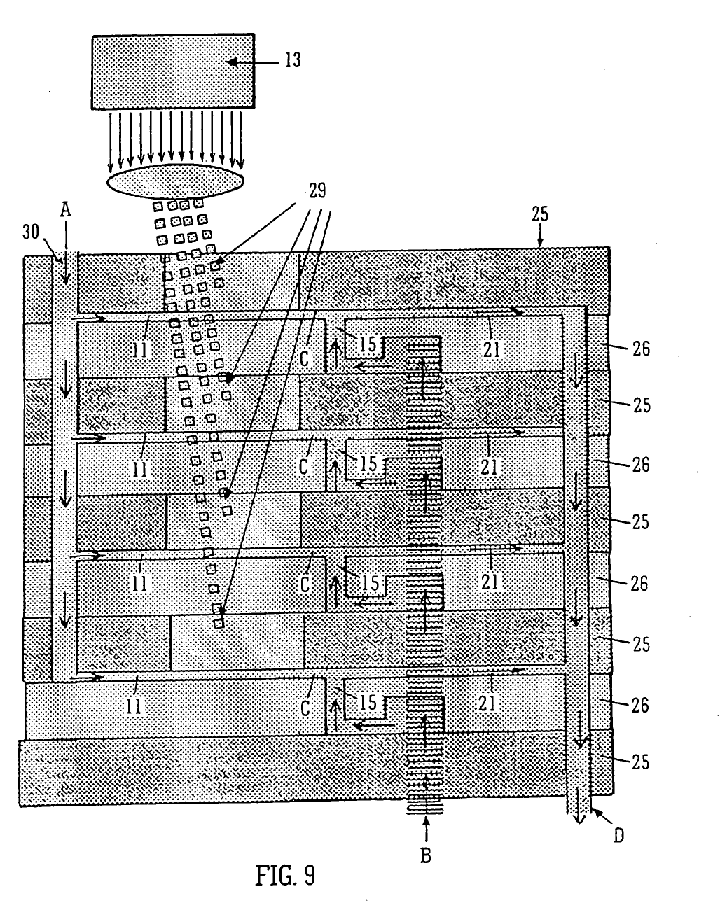

Attenuation or losses when a stimulus passes through multiple aligned widows and conduits will limit the performance of stacked structures of the type represented in FIG. 8. For stacked structures it may be preferable to provide direct transmissive links to each of the conduit regions to be exposed to the stimulus. This may be achieved by employing fibre optic or waveguide structures as disclosed in FIG. 7 as part of the stacked system. An arrangement of this type for high throughput synthesis of a single secondary product is represented diagrammatically in FIG. 9 where multiple transmissive structures 29 are incorporated into the structure.

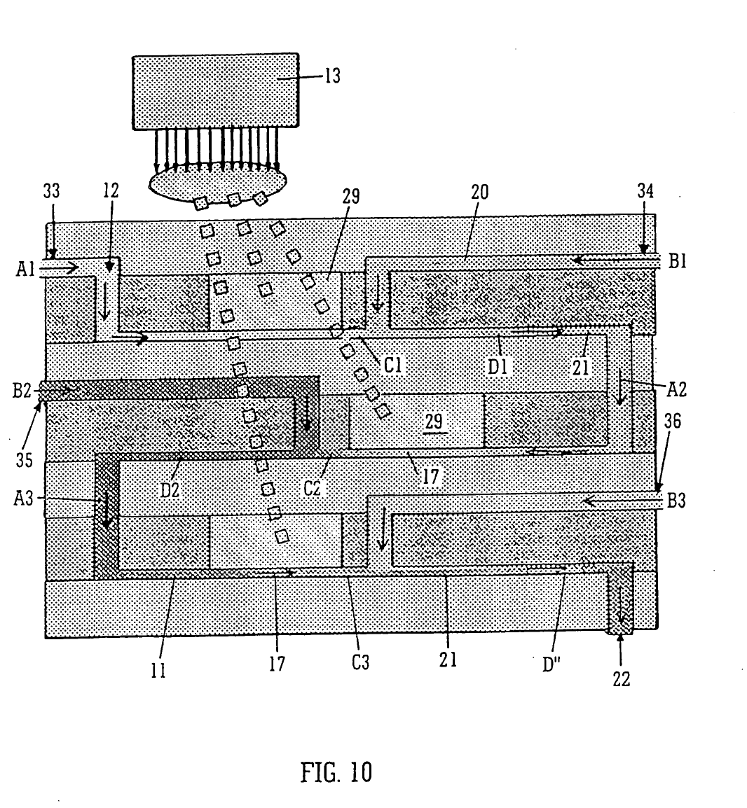

Alternatively, stacked structures may be used to form compact systems with reactors linked in series so that output material from one reactor is utilised as input material for another reactor. Such an arrangement allows a sequential combination of stimulus activated reactions to synthesise relatively complex molecules and may be employed in combinatorial chemical synthesis. FIG. 10 represents a stacked system with such a serial combination of reactors each having a first conduit 11, a second conduit 20 and an outlet conduit 21. Each reactor employs transmissive structures 29 such as optical fibres or waveguides to each separate stimulus region (17). Conduits 33, 34, 35, and 35 may bring different reagents to the reactor streams with stimulus sensitive groups being produced in the streams or introduced before each stimulus region 17.

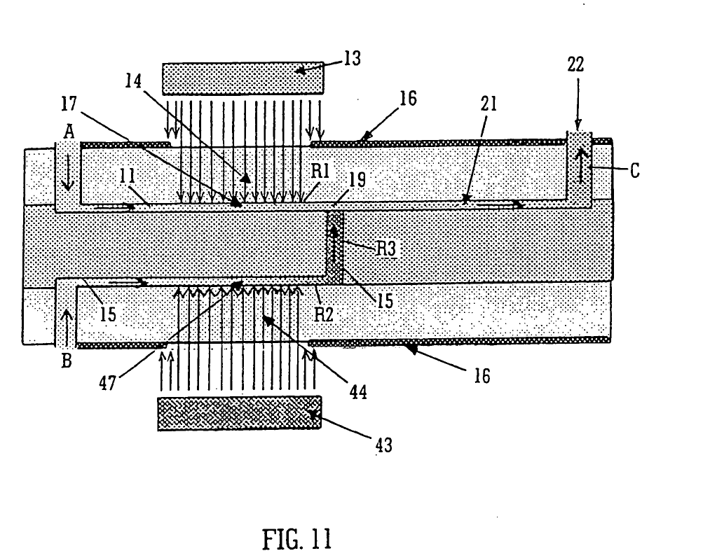

Considering the above, it is possible to see that there are other options where a combination of fluidic mixing, exposure to stimulus and shielding from stimulus may provide advantages over simple illumination (or other stimulation) of a whole mixture of reagents and products. One example might be the stimulus of two reagents as shown in FIG. 11, in different areas and possibly by different stimuli, and the combination of their products in a non-stimulated area to generate product, which itself, may sensitive or labile to the stimuli used to produce the reagents.
A+stimulus 1→R1 //B+stimulus 2→R2 //R1+R2→C

Stimuli applied to reagents A and B above may be different e.g. illumination at different wavelengths, or combinations of photo, electro, and thermal stimuli, but might also be the same, thus allowing stimulus of a pair of reagents in ways or concentrations not possible if they were premixed. Examples of such systems would be those where if one reagent is a much stronger absorber than the other, or where one or more of the desired reactants R1 and R2 is produced by processes in one flow stream will be interfered with by presence of a species in the other flow stream.

A reactor allowing generation of two products by independent stimuli on different source material streams, and then combination of the two products is represented diagrammatically in FIG. 11. Here again the same reference numerals are used as in FIGS. 2 to 10 for parts which are the same. Reference to FIG. 11 stimuli from generators 13, 43 pass via windows 14, 44 to exposed conduit regions 11, 47. Stimulation product streams from conduits 11 and 15 are combined in region 19 and conduit 21 and resultant material issues at an outlet 22.

The process within a micro-engineered reactor of stimulated generation of a reactive reagent as primary product from a source material, followed by reaction with precursor material to form a secondary product, may be repeated sequentially a number of times to generate more complex products. Such an arrangement, especially if operated in parallel as well as sequential format, should provide a means for combinatorial synthesis schemes.

A number of reaction sequences which may be operated in reactors according to the present invention, are represented in FIGS. 12 to 15, where S represents a stimulus causing conversion of a material to which it is applied to a reactive product, and circles represent mixing and reaction stages in regions not subjected to, or shielded from, the stimulus. Extra mixing and reaction stages, not shown in sequences 1-4 shown in FIGS. 12 to 15, may be required to form the photosensitive reagents. (For example, for the conversion of amine to azo groups, or formation of acyl azides).

For Sequence 1, as represented in FIG. 12, reagent A and products C₁ to C₃ are subjected to stimuli in sequential stages. Reagent B₁ to B₂ may be labile to stimulus. FIG. 12 shows three stages of sequence 1 for combinatorial synthesis.

Sequence 2, as represented in FIG. 13, involves addition of a series of active reagents Rn generated by stimulus of precursors An. Reagents B₁ to B₃ and products C₁ to C₃ may be labile to stimulus. Products C₁ to C₃ may need to be separated from impurities including unreacted precursors before subsequent reaction. Such separation is not shown in FIG. 13, which shows three stages of sequence 2 for combinatorial synthesis.

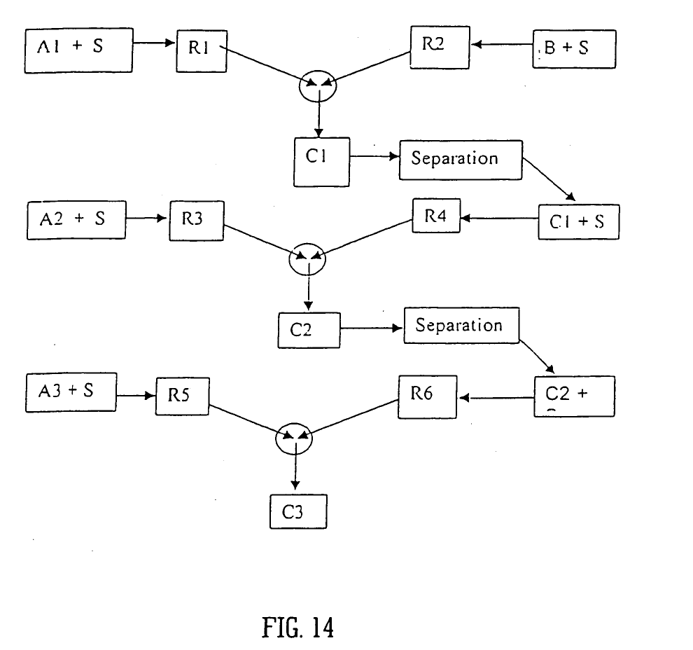

For sequence 3, as represented in FIG. 14, reagents A₁ to A₃, B₁ to B₂ and products C₁ to C₃ are subjected to stimuli in sequential stages. The process forms products C₁ to C₃ corresponding to the selected sequence of generated reagents R₁ to R₅. Separation of products C₁ to C₃ from unconsumed precursors, and side products, may be required as indicated in FIG. 14 which shows three stages of sequence 3 for combinatorial synthesis.

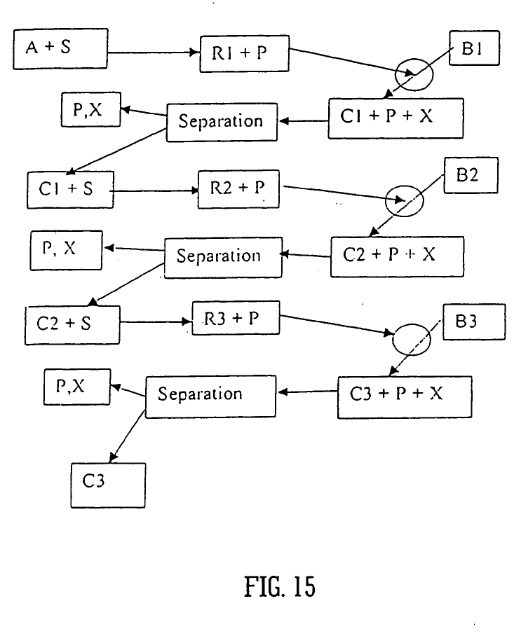

While the above is described in terms of the stimulus of molecules to generate reactive intermediates, the same type of schemes may be employed where the stimulus is used to remove a protective group. Also there may be need for extra steps, such as separation of product from unused reagent or co-products before entry into a subsequent step. These situations are indicated in sequence 4, represented in FIG. 15, which is based on sequence 1 above but where reagents A and B₁ to B₃ incorporate protective groups P. Protective groups from reagents B₁ to B₃ become incorporated in subsequent product C₁ to C₃ and are removed at next stimulus. X represents other co-products/ impurities that may be formed and then removed in separation steps.

For sequence 4, as represented in FIG. 15, reagent A and products C₁ to C₃ are subjected to stimuli in sequential stages. Each reagents B₁ to B₃ may be labile to stimulus, and in this reaction sequence will contain a protecting group which is retained on conversion to products C₁ to C₈. Side products, or impurities, P and X may be separated before each stimulus stage. FIG. 15 shows three stages of sequence 4 for combinatorial synthesis.

It will be understood that within a scheme as described above in connection with FIGS. 12 to 15, the necessity for stimulation, or form of stimulation, may differ at different stages in the sequence. For example, the initial reactant A might react directly with protected reagent B1, and stimulus only be required for protective group removal from compounds C₁ to C₃.

Photochemical reactions that may be carried out in systems according to the present invention are give by way of the following examples which are illustrative and are not intended to be limiting to the specific examples:
1 Generation of benzyne by photolysis of photo labile azo compounds or ketones. The upper part of FIG. 16 shows a process comprising the reaction of a substituted aniline with sodium nitrite and acid to produce a photo labile diazo-compound, followed by the photolysis of the photo labile diazo compound to produce benzyne. The benzyne is reacted with an alkene (olefin) to yield benzocyclobutenes. The lower part of FIG. 16 shows two alternative methods of producing benzyne for use in the process shown in the upper part of FIG. 16, by the photolysis of a ketones, namely diketone (Bicyclo[4.2.0] octa-1,3,5-triene-7, 8-dione) and triketone (Ninhydrin or indan-1,2,3-trione).
2 Curtius rearrangements that are driven by the energetically favourable elimination of N₂ from azide compounds.

This may be promoted thermally or photochemically. An example is the Curtius rearrangement of acyl azides to yield reactive isocyanate species.
R—CON₃+hv→R—N═C═O

These can react with amino or hydroxyl containing compounds. The acyl azides may be produced by the action of sodium azide on acyl chlorides or by nitrous acid on acyl hydrazides.
RCOCl+NaN₃→RCON₃
RCONHNH₂+HNO₂→RCON₃

Photo-labile diazo compounds can similarly be produced by treatment of amines
R—NH₂+NaNO₂+H⁺→R—N₂⁺

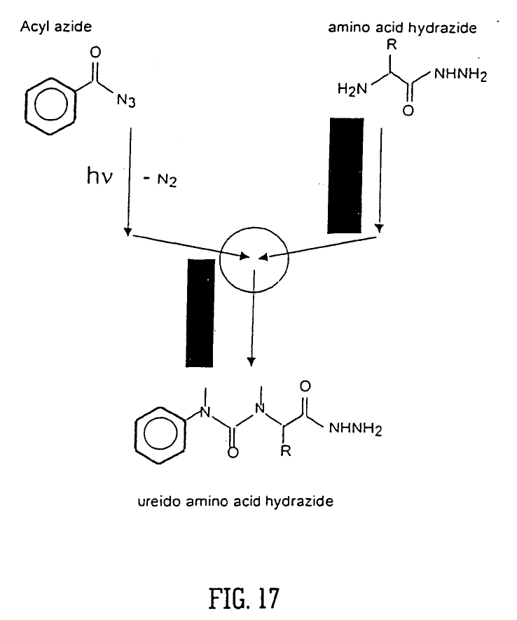

A possible reaction scheme that involves photolysis of an acyl azide followed by mixing and reaction with an amino compound which may itself have a group such as an acyl hydrazide for subsequent conversion to the azide to allow a further addition. An example stage in a photochemical Curtius rearrangement of acyl azide and reaction with an amino compound to yield a ureido amino acid hydrazide (N-phenylcarbamoyl amino acid hydrazide) is indicated in simplified form in FIG. 17. Circles represent mixing stages and dark blocks represent shielding for sections adjacent to stimulated (irradiated) regions.

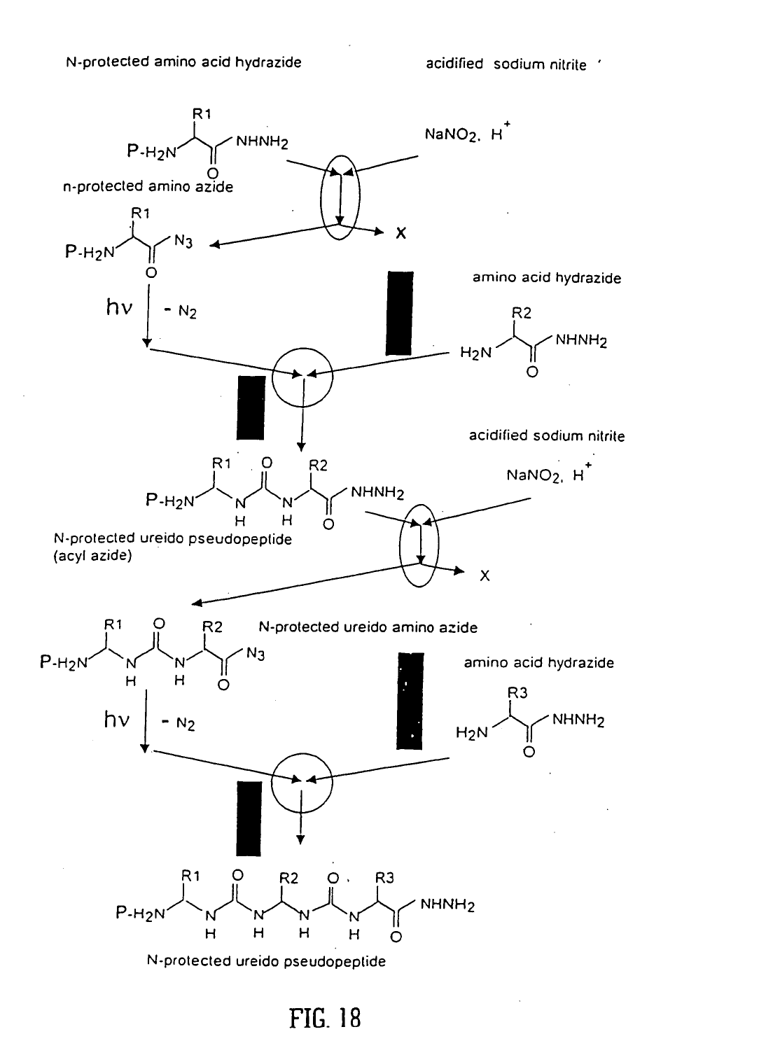

A more extensive scheme is represented in FIG. 18. Such a sequence of reactions might be operated in a combinatorial mode, P represents protective groups. Circles represent mixing stages while ovals represent mixing and possible separation stages to remove contaminants X. Dark blocks represent shielding for sections adjacent to irradiated areas. In FIG. 18, N-protected amino acid hydrazide is contacted with acidified sodium nitrite to yield a N-protected amino azide that is photolysed and reacted with a photo labile amino acid hyrdrazide in a shielded environment to yield a photo labile N-protected ureido pseudopeptide (acyl acid). This compound is further photolysed and contacted with acidified sodium nitrite to yield a N-protected ureido amino azide. This intermediate is further reacted in a shielded environment with a photo labile amino acid hydrazide to yield a N-protected ureido pseudopeptide having the structure shown at the bottom of FIG. 18.
3 Azirine photolysis to generate a reactive nitrile ylide that may be reacted with species with double bonds.

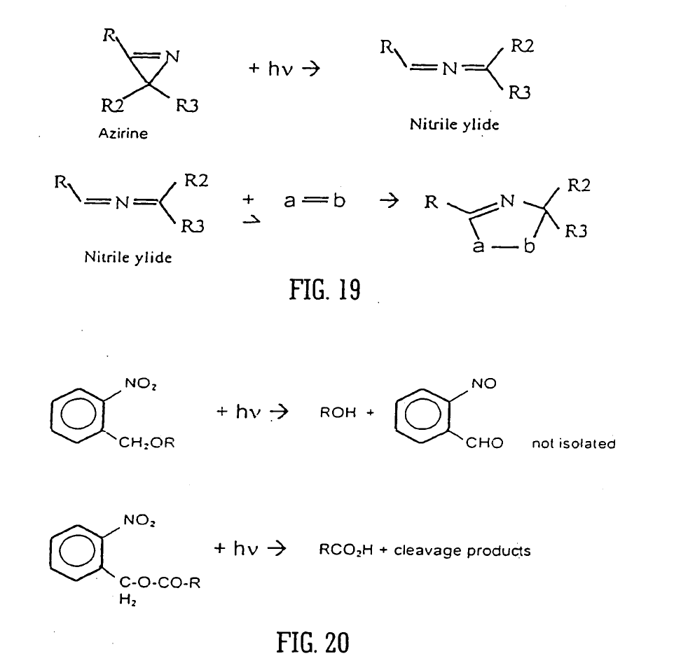

Example reactions are represented in FIG. 19.

The azirines are usually formed by photolysis of vinyl azides, a reaction that gives rise to nitrogen formation. Carried out thermally there is a different stereochemical outcome, but the penalty of heating is that much more decomposition occurs. The conversion of a strained azirine ring is one of a family of similar reactions such as reactions of aziridines (to give azomethine ylids) and epoxides (to give carbonyl ylides).
4 Protecting group chemistries.

A wide range of photocleavable protecting group chemistries are known and used synthetically. In this context, reference is made to “Protecting Groups in Organic Synthesis”, Gree, TWV & Wuts, P.G.M, 1991 (2_{nd} Edition), Wiley & Sons, NY. Such protecting group chemistries are applicable using microfluidic photolysisi reaction structures. Sulphonic acid esters and o-nitrobenzyl ethers have been applied to protection of hydroxyl groups (alcohols), o-nitrobenzylesters and amides to the protection of carboxylic acid and amide groups. Groups of the form of o-nitrobenzyloxycarbonyl are applicable to the protection of amines.

Cleavable sulphonic acid esters are used to protect alcohols ROH. For example,
ArSO₂OR+hv→Ar.+SO₂+OR→SO₂ ArH+ROH (2×H from solvent).

Similarly cleavable o-nitrobenzyl ethers are used to protect alcohols ROH, and cleavable o-nitrobenzyl esters are used to protect carboxylic acids. RCO2H. These processes are represented in FIG. 20.

Generally such protective group chemistries might be applied in micro-systems according to the present invention according to the reaction sequence of the type shown as FIG. 15 earlier.

Free radical species generated photochemically, or by discharge.

In gas phase the lifetime of free radicals from small molecules like NH₃, N₂H₄, H₂O, H₂O₂, H₂, Cl₂, HCl, O₂, N₂, C₂H₄, acetone, formaldehyde etc are sufficient to allow detection in flowing systems. They could be applied in mixed gas/liquid systems with radicals generated and carried in gas phase, and then reacted on contact with liquid reagent. Some larger more stable radicals may be useable in all liquid systems where transit and mixing times can be brought down to milliseconds in microengineered equipment.

1. A chemical reactor comprising a first micro-engineered discrete flow passage for receiving a first chemical fluid (A) in which a chemical change or reaction the fluid can be initiated by subjecting the fluid to a stimulus characterized in that, a stimulation means (13) located in, or adjacent to, the first flow passage (11) and operable to stimulate a chemical change or reaction in the first fluid (A) to produce a stimulation product (R1), a second micro-engineered discrete flow passage (15, 20) for receiving a second chemical fluid (B) which will interact with the stimulation product (R1) when contacted by the product (R1), said first and second flow passages (11, 15) converging at a first region (19) to form an outlet passage (21) within which the first fluid (A) and product (R1) may contact each other to form a product (C).

2-42. (Cancelled)
